(19) United States
(12) Patent Application Publication
(10) Pub. No.: US 2026/0291831 A1
(43) Pub. Date: Sep. 24, 2026

(54) SYSTEM AND METHOD FOR IDENTIFYING ANOMALOUS NETWORK DEVICES OR SERVICES USING GRADIENT BOOSTING AND LARGE LANGUAGE MODELS

(71) Applicant: ORACLE INTERNATIONAL CORPORATION, Redwood Shores, CA (US)

(72) Inventors: Sriram Murthy, Bengaluru (IN); Joy Chatterjee, Bengaluru (IN)

(21) Appl. No.: 19/085,764

(22) Filed: Mar. 20, 2025

(51) Int. Cl. H04L 41/50; H04L 9/40; H04L 41/16; H04L 41/5074

(52) U.S. Cl. CPC H04L 41/5032; H04L 41/16; H04L 41/5074; H04L 63/1425

(57) ABSTRACT

Embodiments described here are generally related to cloud computing or cloud infrastructure environments, and are particularly directed to systems and methods for identifying anomalous network devices or services using a combination of gradient boosting and large language models. In accordance with an embodiment, the system or method comprises, in response to detecting a reduced performance metric or performance anomaly: (a) analyzing the health metrics of network devices or services in the environment, using a gradient boosting decision tree model, to identify unhealthy devices or services; (b) obtaining device/service management tickets that have been raised on those devices or services during a time period prior to the reduced performance metric or performance anomaly; and (c) using a large language model to perform an analysis of the device/service management tickets to determine a set of the devices or services likely causing the reduced performance metric or performance anomaly.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

Embodiments described here are generally related to cloud computing or cloud infrastructure environments, and are particularly directed to systems and methods for identifying anomalous network devices or services using a combination of gradient boosting and large language models.

### BACKGROUND

A typical cloud computing or cloud infrastructure environment comprises a large variety of computing hardware, software resources, cloud interfaces, or other application program interfaces that provide access to shared cloud resources.

In such environments, performance errors or anomalies occasionally occur, resulting in an impact to system performance and the generation of a management ticket directed to finding and resolving the underlying error or performance anomaly. Such resolutions may include, for example, the development and implementation of a firmware or software update or patch.

However, in complex cloud environments, containing a high number of network devices or services, when the system experiences a large-scale event, it can be difficult to quickly identify resolutions to system anomalies using a manual approach or statistical-based automation.

Although techniques such as large language models (LLMs), which are useful in analyzing natural language statements, can be applied to administrative activities such as configuring a system; such techniques are less commonly used in analyzing tabular or other forms of numeric data, such as metrics from devices or services.

### SUMMARY

Embodiments described here are generally related to cloud computing or cloud infrastructure environments, and are particularly directed to systems and methods for identifying anomalous network devices or services using a combination of gradient boosting and large language models.

In accordance with an embodiment, the system or method comprises, in response to detecting a reduced performance metric or performance anomaly: (a) analyzing the health metrics of network devices or services in the environment, using a gradient boosting decision tree model, to identify unhealthy devices or services; (b) obtaining device/service management tickets that have been raised on those devices or services during a time period prior to the reduced performance metric or performance anomaly; and (c) using a large language model to perform an analysis of the device/service management tickets to determine a set of the devices or services likely causing the reduced performance metric or performance anomaly.

### BRIEF DESCRIPTION OF THE DRAWINGS

FIG. 1 illustrates a system for providing a cloud infrastructure environment, in accordance with an embodiment.

FIG. 2 illustrates a system for providing a cloud infrastructure environment, in accordance with an embodiment.

FIG. 3 illustrates a system for identifying anomalous network devices or services using a combination of gradient boosting and large language models, in accordance with an embodiment.

FIG. 4 further illustrates identifying anomalous network devices or services using a combination of gradient boosting and large language models, in accordance with an embodiment.

FIG. 5 further illustrates identifying anomalous network devices or services using a combination of gradient boosting and large language models, in accordance with an embodiment.

FIG. 6 further illustrates identifying anomalous network devices or services using a combination of gradient boosting and large language models, in accordance with an embodiment.

FIG. 7 further illustrates identifying anomalous network devices or services using a combination of gradient boosting and large language models, in accordance with an embodiment.

FIG. 8 illustrates a method for identifying anomalous network devices or services using a combination of gradient boosting and large language models, in accordance with an embodiment.

### DETAILED DESCRIPTION

Embodiments described here are generally related to cloud computing or cloud infrastructure environments, and are particularly directed to systems and methods for identifying anomalous network devices or services using a combination of gradient boosting and large language models.

A typical cloud computing or cloud infrastructure environment comprises a large variety of computing hardware, software resources, cloud interfaces, or other application program interfaces that provide access to shared cloud resources.

In such environments, performance errors or anomalies occasionally occur, resulting in an impact to system performance and the generation of a management ticket directed to finding and resolving the underlying error or performance anomaly. Such resolutions may include, for example, the development and implementation of a firmware or software update or patch.

However, in complex cloud environments, containing a high number of network devices or services, when the system experiences a large-scale event, it can be difficult to quickly identify resolutions to system anomalies using a manual approach or statistical-based automation.

Although techniques such as large language models (LLMs), which are useful in analyzing natural language statements, can be applied to administrative activities such as configuring a system; such techniques are less commonly used in analyzing tabular or other forms of numeric data, such as metrics from devices or services.

Embodiments described here are generally related to cloud computing or cloud infrastructure environments, and are particularly directed to systems and methods for identifying anomalous network devices or services using a combination of gradient boosting and large language models.

In accordance with an embodiment, the system or method comprises, in response to detecting a reduced performance metric or performance anomaly: (a) analyzing the health metrics of network devices or services in the environment, using a gradient boosting decision tree model, to identify unhealthy devices or services; (b) obtaining device/service management tickets that have been raised on those devices or services during a time period prior to the reduced performance metric or performance anomaly; and (c) using a large language model to perform an analysis of the device/service management tickets to determine a set of the devices or services likely causing the reduced performance metric or performance anomaly.

### Cloud Infrastructure Environments

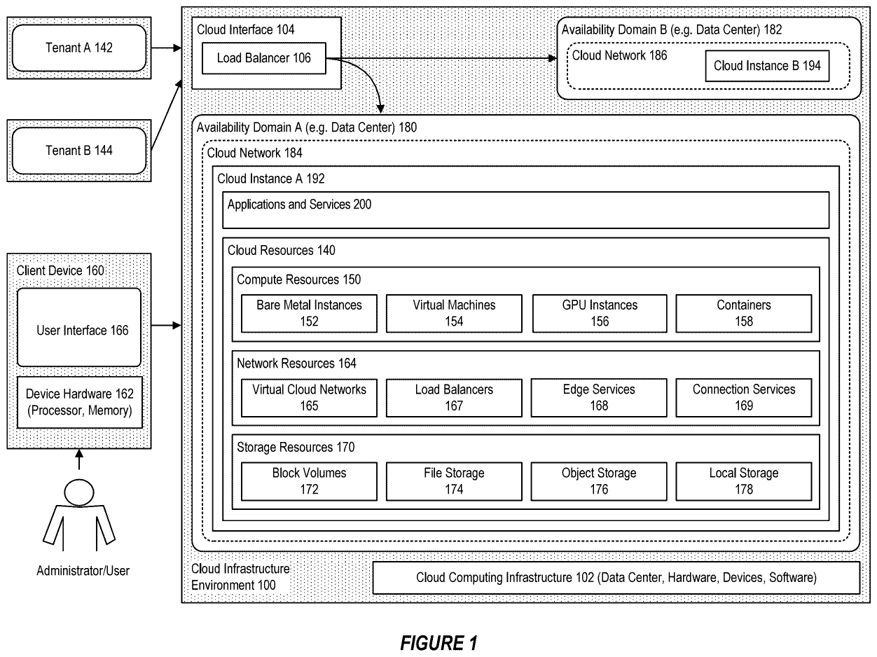

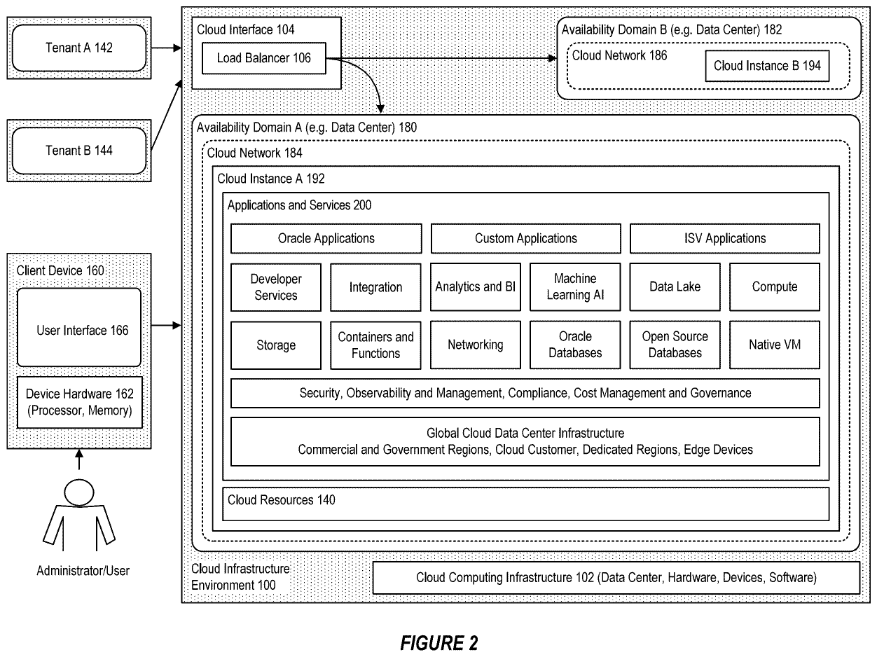

FIGS. 1 and 2 illustrate a system for providing a cloud infrastructure environment, in accordance with an embodiment.

In accordance with an embodiment, the components and processes illustrated in FIG. 1, and as further described herein with regard to various embodiments, can be provided as software or program code executable by a computer system or other type of processing device, for example a cloud computing system.

The illustrated example is provided for purposes of illustrating a computing environment which can be used to provide dedicated or private label cloud environments, for use by tenants of a cloud infrastructure in accessing subscription-based software products, services, or other offerings associated with the cloud infrastructure environment. In accordance with other embodiments, the various components, processes, and features described herein can be used with other types of cloud computing environments.

As illustrated in FIG. 1, in accordance with an embodiment, a cloud infrastructure environment 100 can operate on a cloud computing infrastructure 102 comprising hardware (e.g., processor, memory), software resources, and one or more cloud interfaces 104 or other application program interfaces (API) that provide access to the shared cloud resources via one or more load balancers 106.

In accordance with an embodiment, the cloud infrastructure environment supports the use of availability domains, such as, for example, availability domains A 180, B 182, which enables customers to create and access cloud networks 184, 186, and run cloud instances A 192, B 194.

In accordance with an embodiment, a tenancy can be created for each cloud tenant/customer, for example tenant A 142, B 144, which provides a secure and determined partition within the cloud infrastructure environment within which the customer can create, organize, and administer their cloud resources. A cloud tenant/customer can access an availability domain and a cloud network to access each of their cloud instances.

In accordance with an embodiment, a client device, such as, for example, a computing device 160 having a device hardware 162 (e.g., processor, memory), and graphical user interface 166, can enable an administrator other user to communicate with the cloud infrastructure environment via a network such as, for example, a wide area network, local area network, or the Internet, to create or update cloud services.

In accordance with an embodiment, the cloud infrastructure environment provides access to shared cloud resources 140 via, for example, a compute resources layer 150, a network resources layer 164, and/or a storage resources layer 170. Customers can launch cloud instances as needed, to meet compute and application requirements. After a customer provisions and launches a cloud instance, the provisioned cloud instance can be accessed from, for example, a client device.

In accordance with an embodiment, the compute resources layer can comprise resources, such as, for example, bare metal cloud instances 152, virtual machines 154, graphical processing unit (GPU) compute cloud instances 156, and/or containers 158. The compute resources layer can be used to, for example, provision and manage bare metal compute cloud instances, or provision cloud instances as needed to deploy and run applications, as in an on-premises data center.

For example, in accordance with an embodiment, the cloud infrastructure environment can provide control of physical host (bare metal) machines within the compute resources layer, which run as compute cloud instances directly on bare metal servers, without a hypervisor.

In accordance with an embodiment, the cloud infrastructure environment can also provide control of virtual machines within the compute resources layer, which can be launched, for example, from an image, wherein the types and quantities of resources available to a virtual machine cloud instance can be determined, for example, based upon the image that the virtual machine was launched from.

In accordance with an embodiment, the network resources layer can comprise a number of network-related resources, such as, for example, virtual cloud networks (VCNs) 165, load balancers 167, edge services 168, and/or connection services 169.

In accordance with an embodiment, the storage resources layer can comprise a number of resources, such as, for example, data/block volumes 172, file storage 174, object storage 176, and/or local storage 178.

In accordance with an embodiment, the cloud environment can include a container orchestration system, and container orchestration system API, that enables containerized application workflows to be deployed to a container orchestration environment, for example a Kubernetes (k8s) cluster.

For example, in accordance with an embodiment, the cloud environment can be used to provide containerized compute cloud instances within the compute resources layer, and a container orchestration implementation (e.g., Oracle Cloud Infrastructure Container Engine for Kubernetes (OKE)), can be used to build and launch containerized applications or cloud-native applications, specify compute resources that the containerized application requires, and provision the required compute resources.

As illustrated in FIG. 2, in accordance with an embodiment, the cloud infrastructure environment can include a range of complementary cloud-based components, for example as cloud infrastructure applications and services 200, that enable organizations or enterprise customers to operate their applications and services in a highly-available hosted environment.

By way of example, in accordance with an embodiment, a self-contained cloud region can be provided as a complete, e.g., Oracle Cloud Infrastructure (OCI) dedicated region within an organization's data center that offers the data center operator the agility, scalability, and economics of a public cloud, while retaining full control of their data and applications to meet security, regulatory, or data residency requirements.

For example, in accordance with an embodiment, such an environment can include racks physically and managed by a cloud infrastructure provider; customer's racks; access for cloud operations personnel for setup and hardware support; customer's data center power and cooling; customer's floor space; an area for customer's data center personnel; and a physical access cage.

In accordance with an embodiment, a dedicated region offers to a tenant/customer the same set of infrastructure-as-a-service (IaaS), platform-as-a-service (PaaS), and software-as-a-service (SaaS) products or services available in the cloud infrastructure provider's public cloud regions, such as, for example, ERP, Financials, HCM, and SCM. A customer can seamlessly lift and shift legacy workloads using the cloud infrastructure provider's services, for example bare metal compute, VMs, and GPUs; database services, for example Autonomous Database; or container-based services, for example Container Engine for Kubernetes.

In accordance with an embodiment, a cloud infrastructure environment can operate according to infrastructure-as-a-service (IaaS) model that enables the environment to provide virtualized computing resources over a public network (e.g., the Internet).

In an IaaS model, a cloud infrastructure provider can host the infrastructure components (e.g., servers, storage devices, network nodes (e.g., hardware), deployment software, platform virtualization (e.g., a hypervisor layer), or the like). In some cases, a cloud infrastructure provider may also supply a variety of services to accompany those infrastructure components (example services include billing software, monitoring software, logging software, load balancing software, or clustering software). Thus, as these services may be policy-driven, IaaS users may be able to implement policies to drive load balancing to maintain application availability and performance.

In accordance with an embodiment, IaaS customers may access resources and services through a wide area network (WAN), such as the Internet, and can use the cloud infrastructure provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, or managing disaster recovery.

In accordance with an embodiment, a cloud infrastructure provider may, but need not be, a third-party service that specializes in providing (e.g., offering, renting, selling) IaaS. An entity might also opt to deploy a private cloud, becoming its own provider of infrastructure services.

In accordance with an embodiment, IaaS deployment is the process of putting a new application, or a new version of an application, onto a prepared application server or the like. It may also include the process of preparing the server (e.g., installing libraries, or daemons). This is often managed by the cloud infrastructure provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like.

In accordance with an embodiment, IaaS provisioning may refer to acquiring computers or virtual hosts for use, and even installing needed libraries or services on them. In most cases, deployment does not include provisioning, and the provisioning may need to be performed first.

In accordance with an embodiment, challenges for IaaS provisioning include the initial challenge of provisioning the initial set of infrastructure before anything is running. Second, there is the challenge of evolving the existing infrastructure (e.g., adding new services, changing services, or removing services) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In accordance with an embodiment, a cloud infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more infrastructure elements are desired and/or added, the infrastructure may incrementally evolve.

In accordance with an embodiment, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

### Identification of Network Device or Service Anomalies

In complex cloud environments, containing a high number of network devices or services, when the system experiences a large-scale event, it can be difficult to quickly identify resolutions to system anomalies using a manual approach or statistical-based automation.

Although techniques such as large language models (LLMs), which are useful in analyzing natural language statements, can be applied to administrative activities such as configuring a system; such techniques are less commonly used in analyzing tabular or other forms of numeric data, such as metrics from devices or services.

Embodiments described here are generally related to cloud computing or cloud infrastructure environments, and are particularly directed to systems and methods for identifying anomalous network devices or services using a combination of gradient boosting and large language models.

In accordance with an embodiment, the system or method comprises, in response to detecting a reduced performance metric or performance anomaly: (a) analyzing the health metrics of network devices or services in the environment, using a gradient boosting decision tree model, to identify unhealthy devices or services; (b) obtaining device/service management tickets that have been raised on those devices or services during a time period prior to the reduced performance metric or performance anomaly; and (c) using a large language model to perform an analysis of the device/service management tickets to determine a set of the devices or services likely causing the reduced performance metric or performance anomaly.

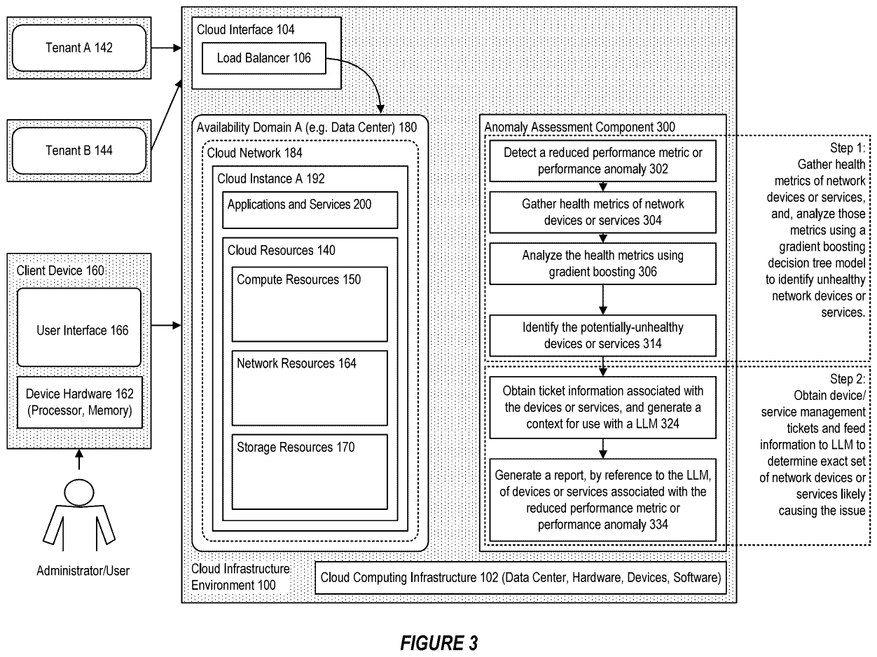

FIGS. 3-5 illustrate a system for identifying anomalous network devices or services using a combination of gradient boosting and large language models, in accordance with an embodiment.

As illustrated in FIG. 3, in accordance with an embodiment, the described approach aims to remedy the aforementioned challenges of identifying resolutions to system anomalies in complex cloud environments, by identifying anomalous network devices or services using a combination of machine learning (ML) such as, for example, gradient boosting techniques, and a large language model (LLM) in a two-step approach:

Step 1: In a given region of a cloud environment (for example, within a particular availability domain) where an issue is reported, such as a reduced performance metric or performance anomaly, gather the health metrics of network devices or services within the cloud environment, and, analyze those health metrics using a gradient boosting decision tree model (for example, XGBoost) to identify unhealthy network devices or services.

Step 2: After the unhealthy network devices or services are identified, obtain ticket information, such as device/service management tickets (for example, JIRA or other issue-tracking tickets) that have been raised on these network devices or services within a particular time period (for example, a 2 hour time period) prior to or before the time of performance impact. This information, together with the results obtained from Step 1, are then fed to an LLM (for example, a Gen-AI, Cohere, Llama, or other type of LLM model) to perform a further/deeper analysis and determine the exact set of network devices or services likely causing the issue.

As further illustrated in FIG. 3, in accordance with an embodiment, the system comprises an anomaly assessment component 300 that operates to:

Detect a reduced performance metric or performance anomaly 302.

Gather health metrics of network devices 304.

Analyze the health metrics using gradient boosting 306.

Identify potentially-unhealthy devices or services 314.

Obtain ticket information associated with the potentially-unhealthy devices or services during a time period prior to the determination of the reduced performance metric or performance anomaly, and generate a context for use with an LLM 324.

Generate a report, by reference to the large language model, of a subset of the potentially-unhealthy devices or services that are likely associated with the reduced performance metric or performance anomaly 334.

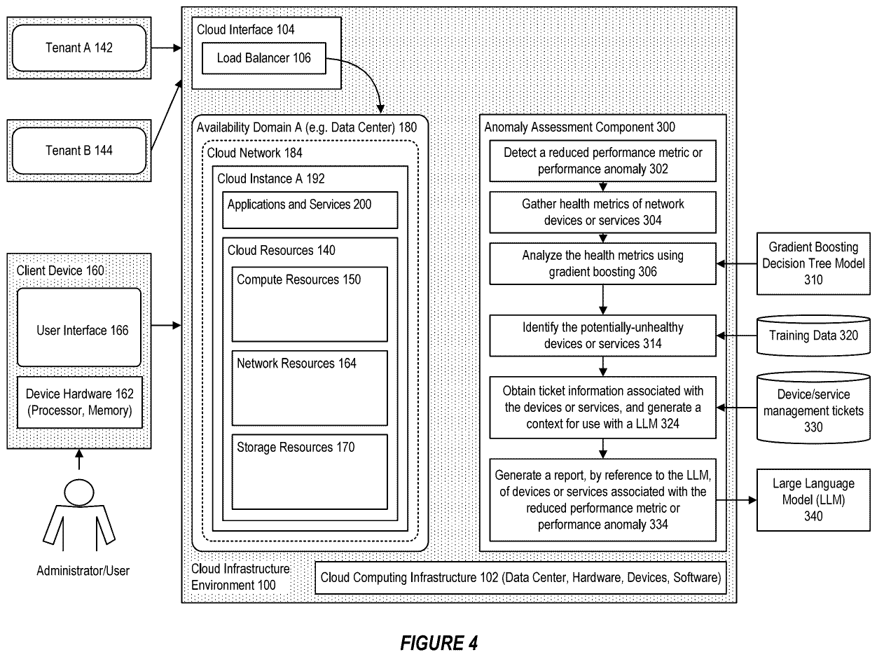

As illustrated in FIG. 4, in accordance with an embodiment, the system can identify the anomalous devices or services causing the reduced performance metric based on a combined use of a gradient boosting decision tree model 310, training data 320, device/service management tickets 330, and large language model 340.

For example, in accordance with an embodiment, gradient boosting can be applied to a time series of data descriptive of the health metrics of the devices or services, to surface anomalous or unhealthy metrics, the descriptions of which can then be used by the LLM.

In accordance with an embodiment, the obtaining of ticket information during the time period prior to the determination of the reduced performance metric includes retrieving device/service management tickets associated with faults, errors, or other performance aspects of the potentially-unhealthy devices or services.

For example, in accordance with an embodiment, the system can receive, for example, JIRA or other issue-tracking tickets that have been raised on these network devices or services within a particular time period (for example, a 2 hour time period) prior to or before the time of performance impact.

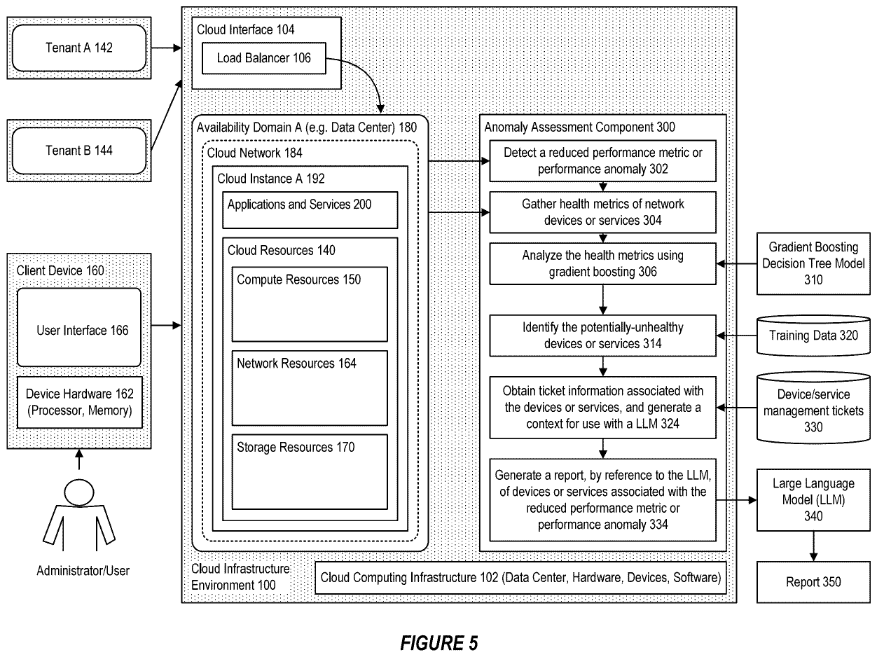

As illustrated in FIG. 5, in accordance with an embodiment, the system can generate, based on the information provided by the large language model with regard to potentially-unhealthy devices or services, a report 350 descriptive of the anomalous devices or services causing the reduced performance metric.

For example, in accordance with an embodiment, the health metrics obtained using a gradient boosting decision tree model, coupled with the ticket information associated with the network devices or services within a particular time period, can be used as a context for use with an LLM's context-mapping or Retrieval-Augmented Generation (RAG) process, to allow the system to pose questions on those devices or services, including identifying the devices or services as potential causes of a reduced performance metric or performance anomaly.

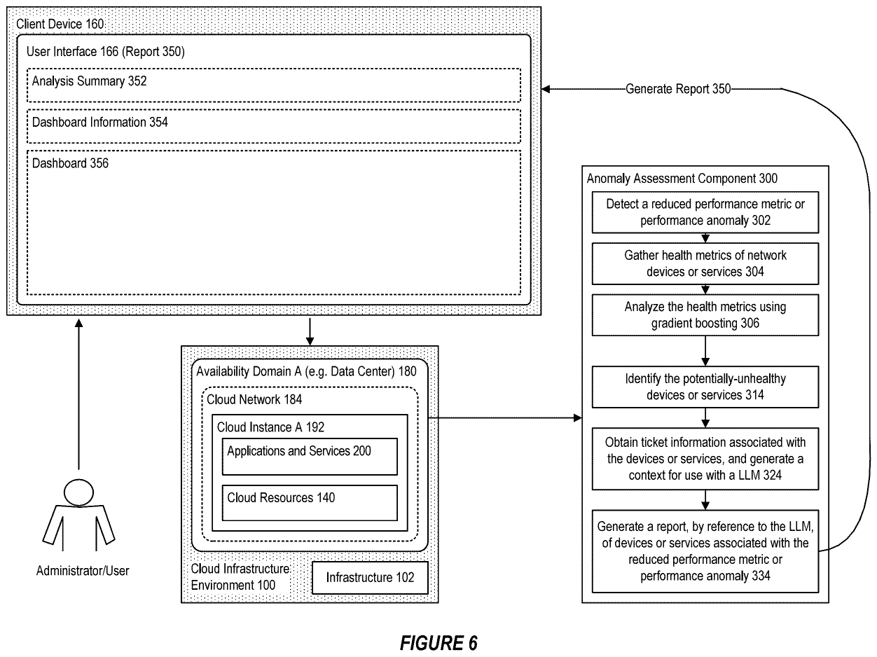

FIG. 6 further illustrates identifying anomalous network devices or services using a combination of gradient boosting and large language models, in accordance with an embodiment.

As illustrated in FIG. 6, in accordance with an embodiment, the system can generate, based on the information provided by the large language model with regard to potentially-unhealthy devices or services, the report descriptive of the anomalous devices or services causing the reduced performance metric can include, for example an analysis summary 352, and dashboard information 354, 356, an example of which is further illustrated below.

### Example Use

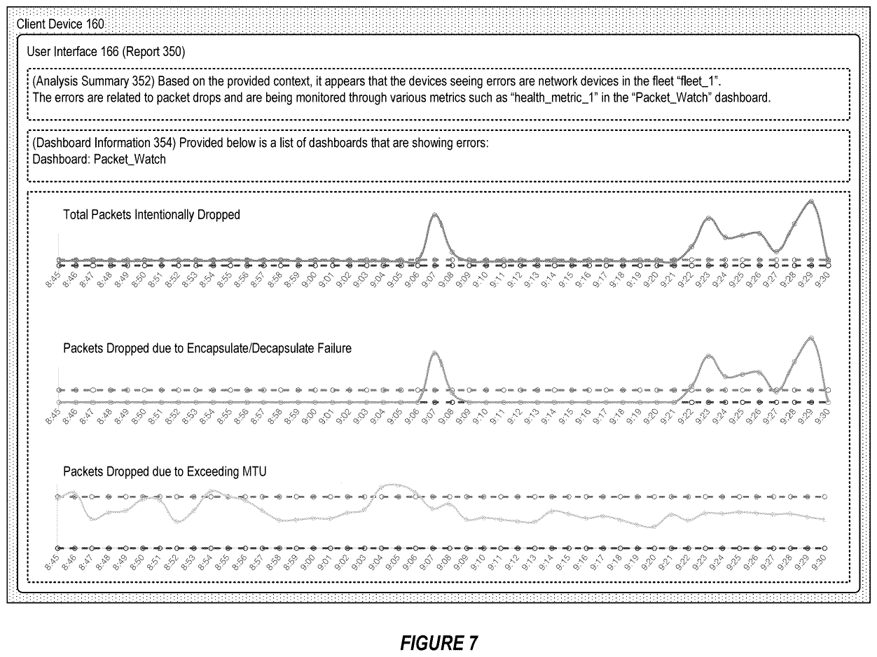

FIG. 7 further illustrates identifying anomalous network devices or services using a combination of gradient boosting and large language models, in accordance with an embodiment, including an example use to illustrate the above-described approach.

In accordance with an embodiment, the method operates to:
1. Identify a set of (tier-0) health metrics for network devices and cloud services in a cloud infrastructure environment.
2. The health metrics are stored in a time series database, such as for example, a Prometheus database, or other database suitable for storing metrics-related data.
3. A health metrics metadata associated with the health metrics, for example, a health metric value range, or minimum and maximum threshold values, are stored in a descriptive file, for example as a JSON file in object storage.
4. A description of the health metric in a natural language (for example, in English) is added to each of the health metrics, and stored along with the health metrics metadata.

For example, in accordance with an embodiment, the system can identify a first health metric (“health_metric_1”) which is indicative of a total number of times a device has failed to encapsulate/decapsulate a data packet, and store the measurements of this health metric in a time series database. The metadata for this health metric can be stored in a JSON format, as illustrated in Example 1. A description such as: “health_metric_1 is a device metric that indicates the total number of times the network device has failed to encapsulate/decapsulate a data packet” can also be stored along with the metadata.

```
{
  “project”: “project_1”,
  “fleet”: “fleet_1”,
  “name”: “health_metric_1”,
  “description”: “Indicates the total number of times the
    network device has failed to encapsulate/decapsulate
    a data packet”,
  “min”: 0,
  “max”: 12000000,
  “critical_watermark”: {
      “min”: 0,
      “max”: 2000000
  },
  “training_datasource”: “ObjectStorage”,
  “training_datasource_details”: {
      “loc”: “training_data ”
  },
  “testing_datasource”: “ObjectStorage”,
  “testing_datasource_details”: {
      “loc”: “testing_data ”
  },
  “query”: “check_health_metric_1( )”
}
```

### Example 1

5. A training dataset for the health metrics, that represents the normal health of these services and devices, are generated and stored in an object storage bucket.

For example, in accordance with an embodiment, the training dataset can include values that are randomly generated, such that 70% of these values will be within the minimum and maximum of a critical watermark threshold value (which indicates that the metric is healthy) and 30% are outside the minimum and maximum of the critical watermark (which indicates that the metric is unhealthy).
6. When the system detects a reduced performance metric or performance anomaly in a region at a particular time instant (tᵢ), the system can, for each health metric:
(a) Fetch the training data for the metric from the object storage bucket.
(b) Fetch the data for every health metric in the candidate metric list, during the incident time window (tⱼ to tₖ) such that, for example:

$${t}_{j} < {t}_{i} < {t}_{k}$$

$${t}_{j} = {t}_{i} - 30 minutes$$

$${t}_{k} = {t}_{i} + 5 minutes$$

This dataset represents the anomalous data for the device and service.
(c) Feed the training data (generated apriori as described previously) and the anomalous data (generated in the above step) for every health metric to a gradient boosting decision tree model, such as for example, an XGBoost model. The XGBoost model will bucketize the health metrics as being OK (healthy) or NOT-OK (unhealthy).
(d) For each health metric that was classified as being unhealthy, a description of the result for the health metric in a natural language (for example, English) is generated.

In the above example, if the “health_metric_1” metric is found to be unhealthy, then the natural language statement that will be generated will be, for example:
“Metric “health_metric_1”, that indicates the total number of times the network device has failed to encapsulate/decapsulate a data packet, has errors.”

Following this step, the system will have several descriptions, corresponding to the unhealthy network devices and cloud services.
7. The system can obtain ticket information associated with the potentially-unhealthy devices or services during a time period prior to the determination of the reduced performance metric or performance anomaly, for example by gathering tickets that have been filed in a ticketing system such as, for example, a JIRA or other issue-tracking system, corresponding to alerts that have happened on the devices two-hours before the incident time.

In accordance with an embodiment, a time period of 2 hours is chosen because that is the time window that is conveniently used by network analysis tools, although other time periods can be alternatively used.
8. For each of the tickets, and from the data contained within the ticket, the system creates a descriptive paragraph, including one or more statements that: (i) provides a description of the alert representing the ticket; (ii) mentions the severity of the alert; (ii) mentions the name of the device; and/or (iv) mentions the location of the device.
9. At the end of Step 8, the system can generate a report including several lines describing the alerts seen on the devices, for example:
At 01:23 on 2025 Jan. 1, an ENCAPSULATE/DECAPSULATE alarm, which
is a Severity 2 alarm, was observed on interface Enet_1 of device Dev_1.
Ticket 1-23456 has been raised against this alert.
This network device is in Region 1, Building 7, Block A.
10. In accordance with an embodiment, the system can create a text file that has data gathered in the above steps and that will serve as a context for a Retrieval-Augmented Generation (RAG) pipeline use with the LLM.
11. The text file is split into tokens and stored in a vector database.
12. Using a text embedding model, such as, for example a cohere.embed-english-v3.0 model, the system creates a Retrieval-Augmented Generation (RAG) pipeline using the data stored in the vector database.
13. The RAG pipeline is provided to an LLM.
14. The system provides a predefined prompt to the LLM, for example “Can you elaborate on the devices seeing errors?”
15. Based on the health metrics data and the alerting data, the LLM will be able to identify the devices that are candidates causing the issue, as illustrated in Example 2:

Based on the provided text, it appears that the errors are related to
one or more network devices.
The metrics indicating errors are:
1. “Intentional” - total packets intentionally dropped.
2. “health_metric_1” - number of times the network device has failed
to encapsulate/decapsulate a data packet.
3. “MTU_exceeded” - total packets dropped due to exceeding
Maximum Transmission Unit (MTU).
These metrics are located in the “Packet_Watch” dashboard.
The text mentions that network devices can cause probe failures if they
go down, since they have around 50 devices connected to them and do not
have failover configured.
The text also mentions that the load balancer may be unhealthy, but it is
not clear if this is related to the network device or other components.

### Example 2

As illustrated in FIG. 7, in accordance with an embodiment, the system can then generate a report descriptive of the anomalous devices or services causing the reduced performance metric, including in this example, by analyzing the metrics or dashboards associated with the network device, creating a context, and providing that information to the LLM for use in generating the report.

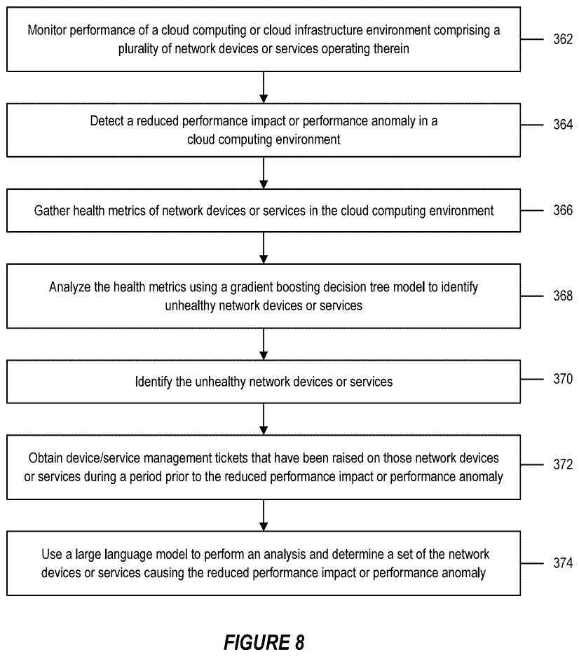

FIG. 8 illustrates a method for identifying anomalous network devices or services using a combination of gradient boosting and large language models, in accordance with an embodiment.

As illustrated in FIG. 8, in accordance with an embodiment, the method comprises, at step 362, monitoring performance of a cloud computing or cloud infrastructure environment comprising a plurality of network devices or services operating therein.

At step 364, in response to detecting a performance anomaly in a cloud computing environment, the method comprises: at step 366, gathering health metrics of network devices or services in the cloud computing environment, and, at step 368, analyzing the health metrics using a gradient boosting decision tree model to identify unhealthy network devices or services.

At step 370, subsequent to identifying the unhealthy network devices or services, the method comprises: at step 372, obtaining device/service management tickets that have been raised on those network devices or services during a time period prior to the reduced performance metric or performance anomaly, and, at step 374, using a large language model to perform an analysis and determining a set of the network devices or services causing the reduced performance metric or performance anomaly.

In accordance with various embodiments, the systems and methods described herein can be implemented using one or more computer, computing device, machine, or microprocessor, including one or more processors, memory and/or computer readable storage media programmed according to the teachings of the present disclosure. Appropriate software coding can readily be prepared by skilled programmers based on the teachings of the present disclosure, as will be apparent to those skilled in the software art.

In some embodiments, the teachings herein can include a computer program product which is a non-transitory computer readable storage medium (media) having instructions stored thereon/in which can be used to program a computer to perform any of the processes of the present teachings. Examples of such storage mediums can include, but are not limited to, hard disk drives, hard disks, hard drives, fixed disks, ROMs, RAMs, EPROMs, EEPROMs, DRAMs, VRAMs, flash memory devices, or other types of storage media or devices suitable for non-transitory storage of instructions and/or data.

The foregoing description has been provided for the purposes of illustration and description. It is not intended to be exhaustive or to limit the scope of protection to the precise forms disclosed. Many modifications and variations will be apparent to the practitioner skilled in the art.

The embodiments were chosen and described in order to best explain the principles of the present teachings and their practical application, thereby enabling others skilled in the art to understand the various embodiments and with various modifications that are suited to the particular use contemplated. It is intended that the scope be defined by the following claims and their equivalents.

What is claimed is:

1. A system for identifying anomalous network devices or services using gradient boosting decision trees coupled with large language models, comprising:
providing a cloud computing or cloud infrastructure environment comprising a plurality of network devices or services operating therein;
wherein the system, in response to detecting a reduced performance metric or performance anomaly in a cloud computing environment, operates to:
gather health metrics of network devices, and
analyze the health metrics using gradient boosting to identify potentially-unhealthy devices or services; and
subsequent to identifying the potentially-unhealthy devices or services,
obtain ticket information associated with the potentially-unhealthy devices or services during a time period prior to the determination of the reduced performance metric or performance anomaly, and generate a context for use with a large language model, and
generate a report, by reference to the large language model, of a subset of the potentially-unhealthy devices or services that are likely associated with the reduced performance metric or performance anomaly.

2. The system of claim 1, further comprising identifying the anomalous devices or services causing the reduced performance metric or performance anomaly based on a combined use of a gradient boosting decision tree model and a large language model.

3. The system of claim 1, wherein the system is provided within a networked computing environment, such as a cloud environment or data center, for identifying anomalous network devices or cloud services.

4. The system of claim 1, wherein the obtaining of ticket information during the time period prior to the determination of the reduced performance metric or performance anomaly includes retrieving device/service management tickets associated with faults, errors, or other performance aspects of the potentially-unhealthy devices or services.

5. The system of claim 1, further comprising generating, based on the information provided by the large language model with regard to potentially-unhealthy devices or services, a report descriptive of the anomalous devices or services causing the reduced performance metric.

6. A method for identifying anomalous network devices or services using gradient boosting decision trees coupled with large language models, comprising:
monitoring performance of a cloud computing or cloud infrastructure environment comprising a plurality of network devices or services operating therein;
in response to detecting a reduced performance metric or performance anomaly in a cloud computing environment,
gathering health metrics of network devices, and
analyzing the health metrics using gradient boosting to identify potentially-unhealthy devices or services; and
subsequent to identifying the potentially-unhealthy devices or services,
obtaining ticket information associated with the potentially-unhealthy devices or services during a time period prior to the determination of the reduced performance metric or performance anomaly, and generate a context for use with a large language model, and
generating a report, by reference to a large language model, of a subset of the potentially-unhealthy devices or services that are likely associated with the reduced performance metric or performance anomaly.

7. The method of claim 6, further comprising identifying the anomalous devices or services causing the reduced performance metric or performance anomaly based on a combined use of a gradient boosting decision tree model and a large language model.

8. The method of claim 6, wherein the method is performed within a networked computing environment, such as a cloud environment or data center, for identifying anomalous network devices or cloud services.

9. The method of claim 6, wherein the obtaining of ticket information during the time period prior to the determination of the reduced performance metric or performance anomaly includes retrieving device/service management tickets associated with faults, errors, or other performance aspects of the potentially-unhealthy devices or services.

10. The method of claim 6, further comprising generating, based on the information provided by the large language model with regard to potentially-unhealthy devices or services, a report descriptive of the anomalous devices or services causing the reduced performance metric.

11. A non-transitory computer readable storage medium, including instructions stored thereon which when read and executed by one or more computers cause the one or more computers to perform a method comprising:
monitoring performance of a cloud computing or cloud infrastructure environment comprising a plurality of network devices or services operating therein;
in response to detecting a reduced performance metric or performance anomaly in a cloud computing environment,
gathering health metrics of network devices, and
analyzing the health metrics using gradient boosting to identify potentially-unhealthy devices or services; and
subsequent to identifying the potentially-unhealthy devices or services,
obtaining ticket information associated with the potentially-unhealthy devices or services during a time period prior to the determination of the reduced performance metric or performance anomaly, and generate a context for use with a large language model, and
generating a report, by reference to a large language model, of a subset of the potentially-unhealthy devices or services that are likely associated with the reduced performance metric or performance anomaly.

12. The non-transitory computer readable storage medium of claim 11, further comprising identifying the anomalous devices or services causing the reduced performance metric or performance anomaly based on a combined use of a gradient boosting decision tree model and a large language model.

13. The non-transitory computer readable storage medium of claim 11, wherein the method is performed within a networked computing environment, such as a cloud environment or data center, for identifying anomalous network devices or cloud services.

14. The non-transitory computer readable storage medium of claim 11, wherein the obtaining of ticket information during the time period prior to the determination of the reduced performance metric or performance anomaly includes retrieving device/service management tickets associated with faults, errors, or other performance aspects of the potentially-unhealthy devices or services.

15. The non-transitory computer readable storage medium of claim 11, further comprising generating, based on the information provided by the large language model with regard to potentially-unhealthy devices or services, a report descriptive of the anomalous devices or services causing the reduced performance metric.
